(19) United States
(12) Patent Application Publication
(10) Pub. No.: US 2007/0259613 A1
(43) Pub. Date: Nov. 8, 2007

(54) Coin Dispensing Apparatus

(76) Inventors: Phillip William Richardson, Ashton-u-Lyne (GB); Malcom Reginald Hallas Bell, Lancashire (GB)

Correspondence Address: Joseph A Calvaruso;Chadbourne & Parke, 30 Rockefeller Plaza, New York, NY, 10112, US

(21) Appl. No.: 10/560,919

(22) PCT Filed: Jun. 17, 2004
(86) PCT No.: PCT/GB04/02587

§ 371 Date: Mar. 26, 2007

(30) Foreign Application Priority Data
Jun. 19, 2003 (GB) 0314323.7

(51) Int. Cl. G07D 9/00

(52) U.S. Cl. 453/32

(57) ABSTRACT

A coin dispensing apparatus comprises a body member (1) a coin source, a rotary member (3) with a plurality of coin receptacles (6) to receive coins from the coin source, a motor (4) to rotate the rotary member so as to move coins in the receptacles along an annular coin path, a coin outlet (10) disposed to one side of the coin path, and a movable ejector device (11) to eject coins from the receptacles through the coin outlet, the ejector device being positioned so that it is moved to from a coin engaging position to a discharge position by a coin as it moves along the annular path to be ejected through the coin outlet, a spring (15) to drive the ejector device from the discharge position to eject the coin through the outlet and thence to the coin engaging position for a next approaching coin to be ejected, and a counting arrangement (17, 18, 19) within the body member (1) responsive to movement of the ejector device to count coins ejected through the outlet.

### FIELD OF THE INVENTION

This invention relates to a coin dispensing apparatus and has particular but not exclusive application to a hopper for dispensing coins in gaming and vending machines.

### BACKGROUND OF THE INVENTION

Hitherto, coin dispensing apparatus in the form of a hopper has been used to dispense coins in gaming machines to provide a prize and also to dispense coins in vending machines to provide change. An example is the Compact Hopper manufactured by Money Controls Limited. Reference is also directed to EP-A-0266021.

The hopper is typically fed with coins from a coin acceptor. A disc-like rotary member has a number of coin receptacles that receive the coins and a motor rotates the rotary member so as to move coins in the receptacles along an annular coin path so that they can be ejected successively from the receptacles through a coin outlet disposed to one side of the path. A spring loaded ejector device ejects coins from the receptacles to the coin outlet. The ejector device is positioned so that it is moved from a coin engaging position against the force of the spring to a discharge position by a coin as it moves along the annular path to be ejected from the coin outlet, so that as the coin comes aligned with the outlet, the force of the spring is released and the ejector device moves from a discharge position so as to eject the coin through the outlet and thence to the coin engaging position for the next approaching coin to be ejected.

An optical counting device has been used to count the coins as they are ejected from the outlet so that the correct payout or change can be dispensed. Hitherto, the counting device has comprised an optical emitter and detector at the coin outlet so that each dispensed coin breaks the optical path between the emitter and the detector to provide a coin count signal.

However, a problem with this conventional counting arrangement is that the optical emitter and detector are mounted on the exterior of the apparatus rendering them vulnerable to attack by fraudsters and vandals. For example, a fraudster may insert a knife blade or other similar instrument through the conventional payout opening of the vending or gaming machine and physically break off the optical counting device. As a result, there is a risk that the dispensing apparatus will erroneously dispense all of the coins in the hopper.

The present invention seeks to provide a coin dispensing apparatus with an improved counting arrangement which is less prone to fraudulent operation and vandalisation.

### SUMMARY OF THE INVENTION

In a first aspect the invention provides coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, and counting means responsive to movement of the ejector device to count coins ejected through the outlet.

Since the counting means is responsive to the movement of the ejector device, it can be housed within the body of the coin dispensing apparatus, thereby rendering the arrangement less accessible to fraudsters and vandals. More particularly, if a vandal jams the operation of the ejector device to confuse the counting means, no coins will be ejected and so the fraudster will be defeated.

The invention also provides a coin dispensing apparatus with an improved ejector device.

In accordance with the invention, there is provided coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, the ejector device comprising first and second coin engaging members movable independently between said coin engaging position and said discharge position.

The invention also provides coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, the ejector device comprising at least one slider member movable between the coin engaging position and the discharge position.

### BRIEF DESCRIPTION OF THE DRAWINGS

In order that the invention may be more fully understood embodiments thereof will now be described by way of example with reference to the accompanying drawings in which:

FIG. 1 is an exploded perspective view from above and one side of a coin dispensing apparatus according to the invention;

FIG. 2 is a front view of the apparatus shown in FIG. 1;

FIG. 3 is a rear view of the apparatus;

FIG. 4 is a side view of the apparatus;

FIG. 5 is a schematic perspective view of the ejector member of the apparatus;

FIG. 6 is a schematic block diagram of electrical coin counting circuitry;

FIGS. 7A-E illustrate successive stages in the ejection of a coin from the coin dispensing apparatus;

FIG. 8 is a schematic plan view of an alternative embodiment of the ejector device in which the two coin engaging members are independently movable;

FIGS. 9A and B are schematic illustrations of the ejector member of FIG. 8 in different operative configurations;

FIG. 10 is a schematic perspective view of another embodiment of ejector device for use in the apparatus; and

FIG. 11 is a sectional of the configuration shown in FIG. 10 taken along the line X-X′.

### DETAILED DESCRIPTION

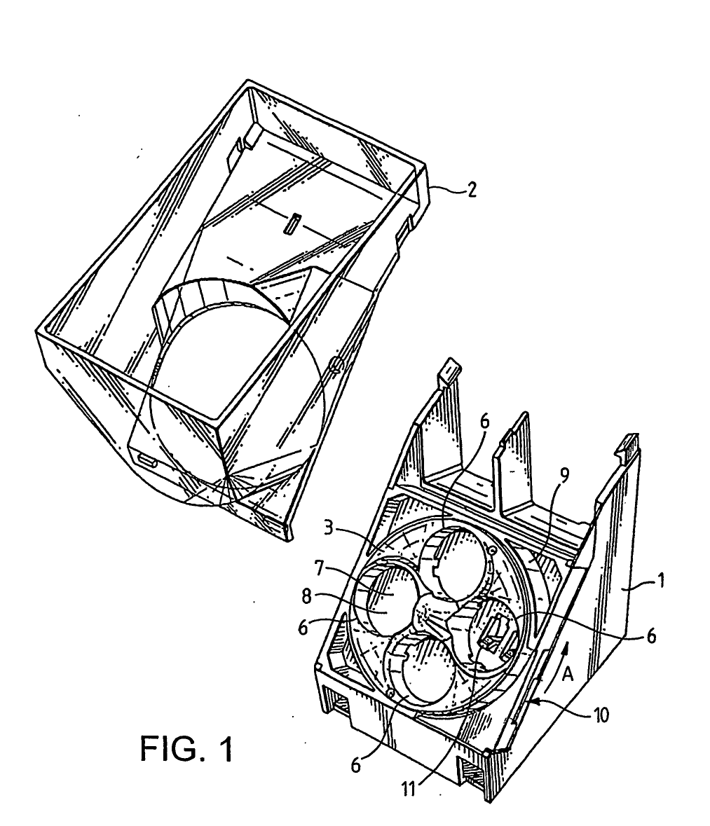

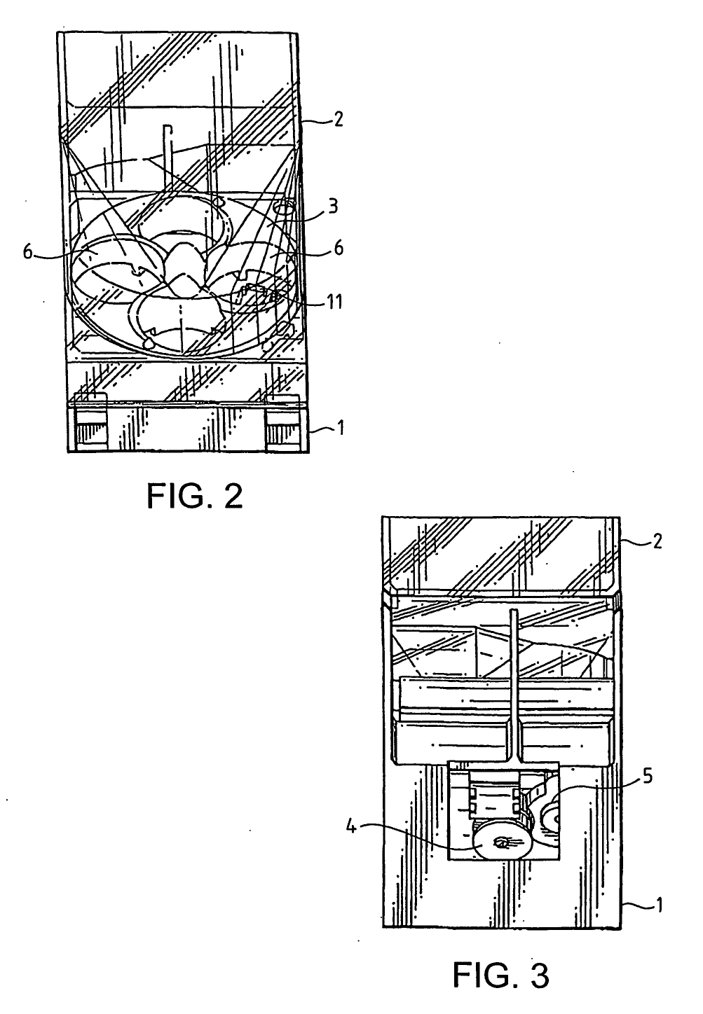

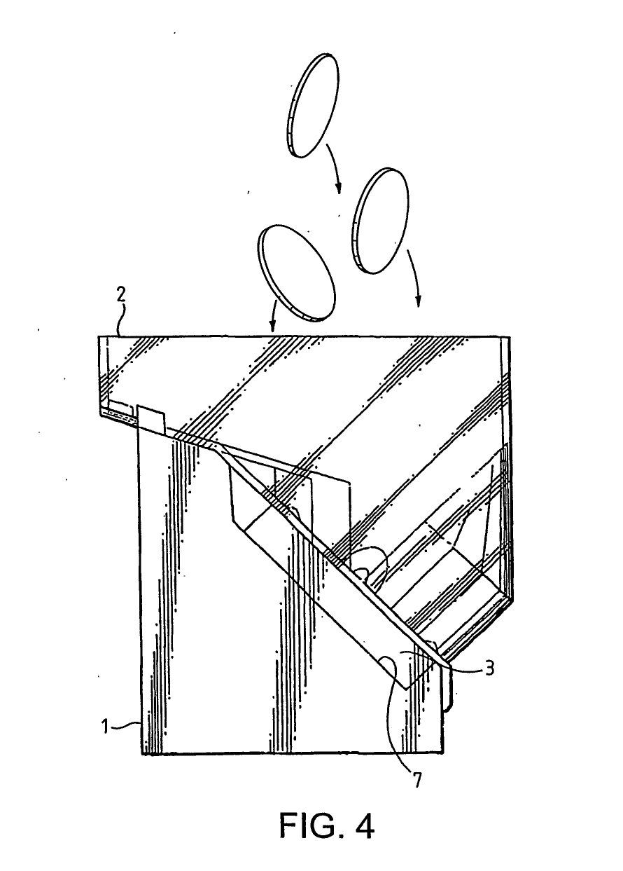

Referring to FIGS. 1 to 4, the coin dispensing apparatus comprises a body member 1, a hopper 2, and a disc-like rotary member 3 mounted on the body member 1. The rotary member 3 is rotated in the direction of arrow A by an electric motor 4 mounted within the body member 1, through a reduction gear train 5. An example of the gear train 5 is described in more detail in EP-A-0266021.

In use, coins fall into the hopper 2, for example from a coin acceptor, so that the hopper acts as a coin source and feeds coins into circular apertures 6 in the rotary member 3. The coins slide on inclined side wall 7 of the body member 1 which has an annular upper surface 8 bounded by a circular side wall 9 around the circular edge of the rotary member 3. A coin outlet 10 is provided in the side wall 9.

A coin ejector device 11 in the form of a pivoted fork member has first and second coin engaging members 11a, 11b protruding through respective openings 12a, 12b in the inclined wall 7 of the body member.

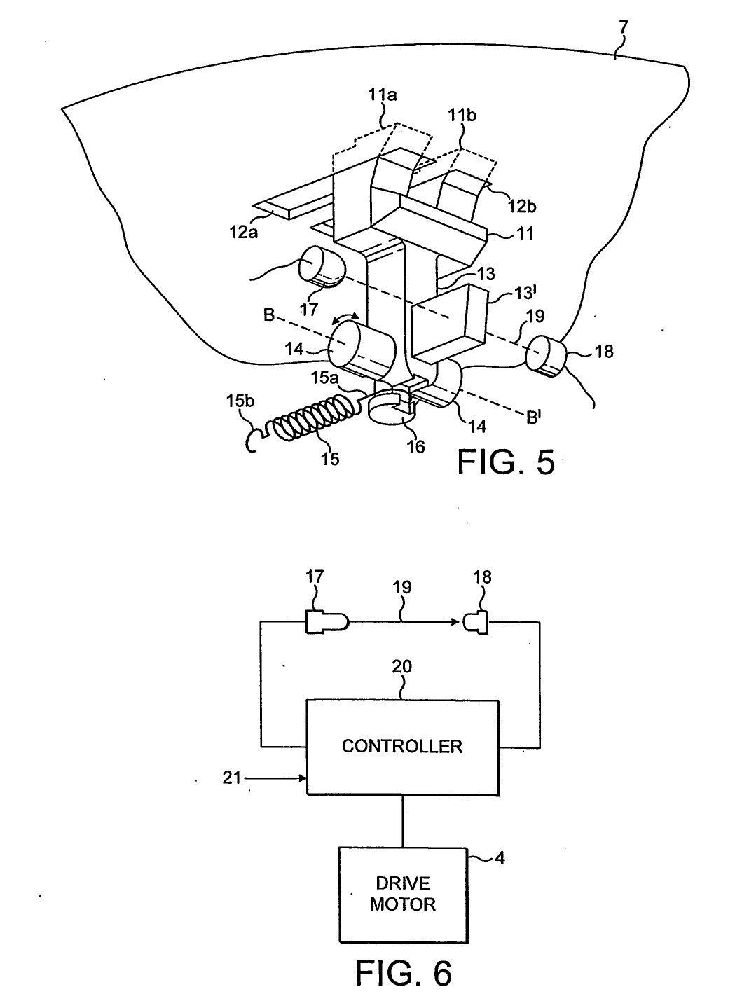

The ejector device 11 is shown in more detail in FIG. 5 and comprises an arm 13 which includes integral lugs 14 that are pivotally mounted in corresponding receptacles within the body member 1 (not shown) so that the device 11 can turn about axis B-B′.

A tension spring 15 is mounted at one end 15a on lug 16 on the arm 13, and at the other end 15b on the body member 1 by a mounting (not shown).

The ejector device 11 can move from a coin engaging position shown in FIG. 5, with the first and second coin engaging members 11a, 11b at one of end of each of the openings 12a, 12b, to a coin dispensing position when an approaching coin on the surface 8 moves the coin engaging members 11a, 11b, towards the other end of the openings 12a, 12b, against the force of spring 15.

In order to count coins, movement of the ejector device 11 between the coin engaging and coin dispensing positions is detected using an optical emitter and detector 17, 18 which may operate with any suitable optical wavelength including non-visible radiation such as infra-red or ultra-violet. In this example, an infra-red detector is used. The optical path 19 between the emitter and detector 17, 18 is interrupted by an arm 13′ on the ejector device 11. In the coin engaging position shown in FIG. 5, the arm 13′ interrupts the optical path 19 so that detector 18 detects no radiation from the emitter 17. However, when the device 11 rotates about axis B-B′ to the coin dispensing position, in which the coin engaging members 11a, 11b are moved to the opposite ends of the openings 12a, 12b, the optical path 19 is opened as a result, detector 18 produces an electrical output. As will be explained later, the ejector device 11 rotates back and forth for each coin ejection and so a coin count signal is developed by the detector 18.

FIG. 6 illustrates the electrical circuitry of the apparatus. A controller 20 receives the count signal from the detector 18 and also controls energisation of the emitter 17. When an instruction is received to pay out coins, a pay instruction 21, which may comprise an instruction to pay out a predetermined number of coins, is received by the controller 20, for example from a control unit (not shown) associated with a vending or gaming machine. In use, the controller 20 energises the drive motor 4 so as to rotate member 3 until the number of count signals developed by detector 18 corresponds to the coin number given in the pay instruction 21.

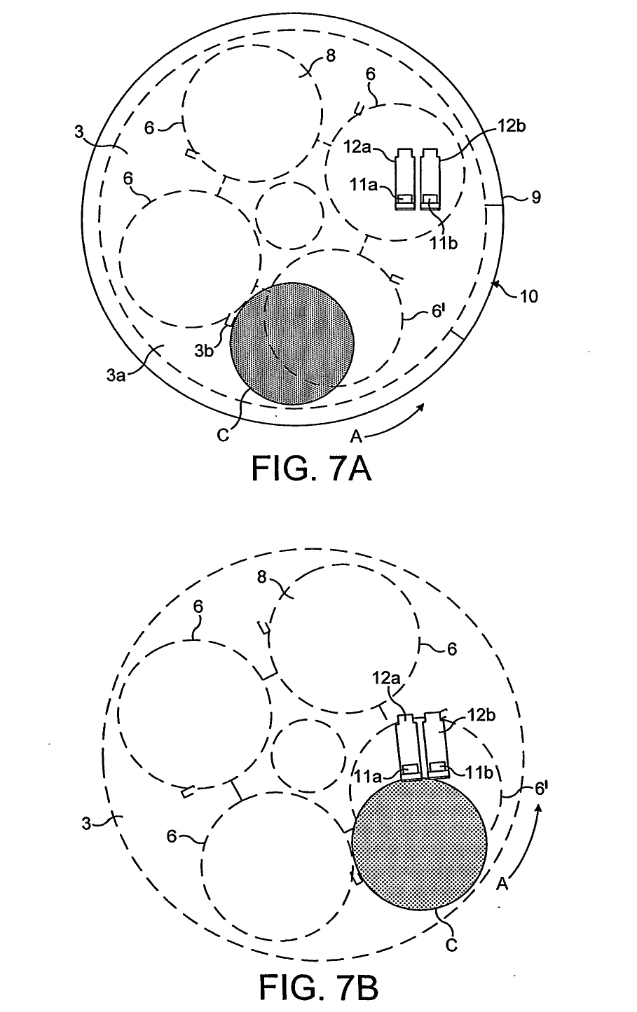

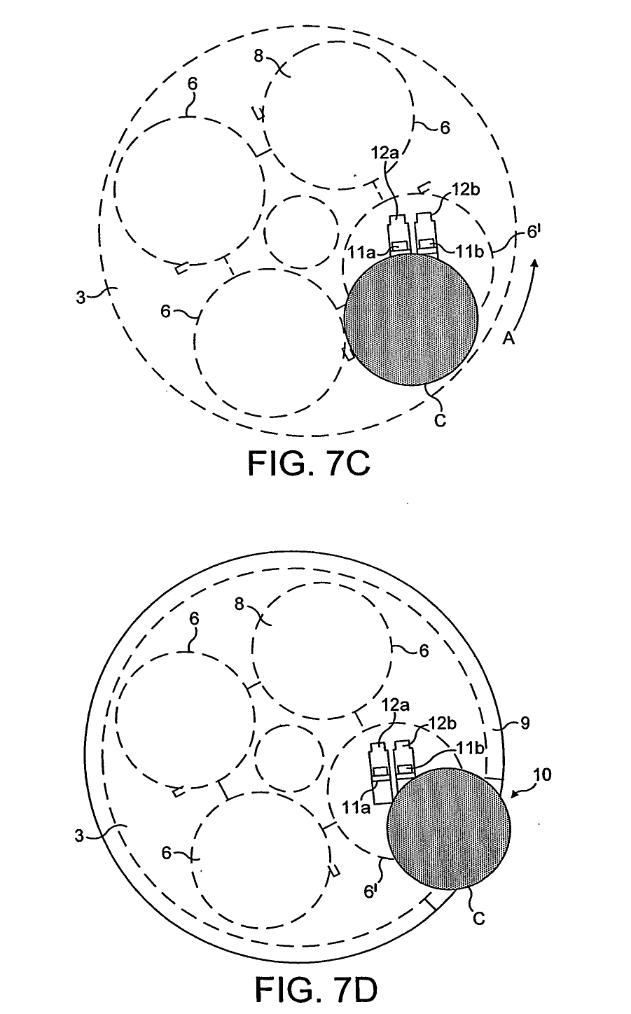

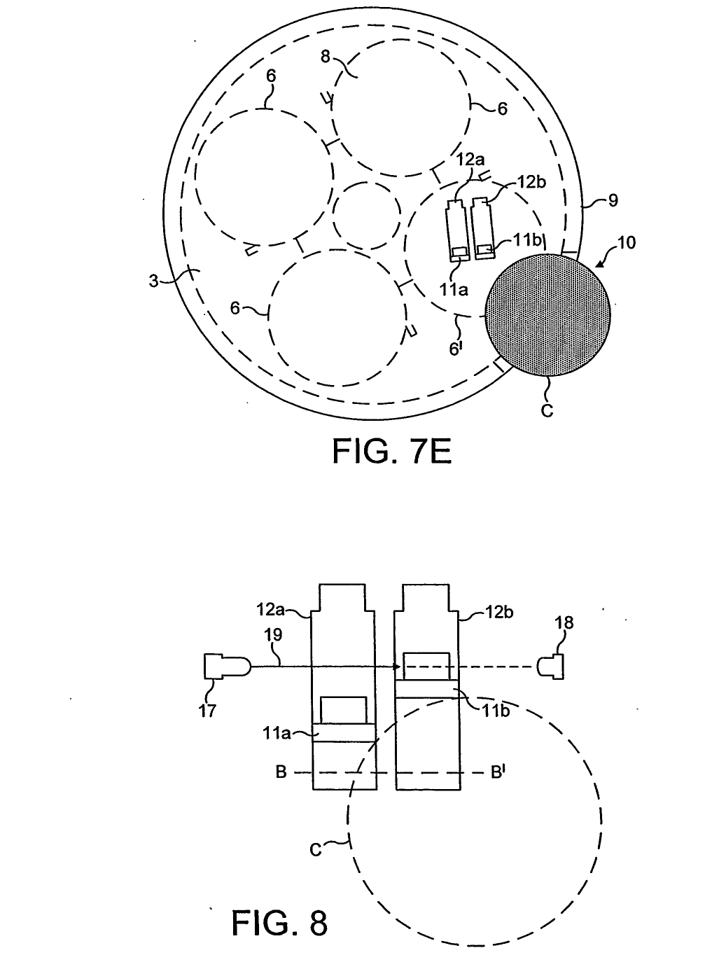

Operation of the device will now be described in more detail with reference to FIGS. 7A-7E. FIG. 7A shows a coin C which has passed through aperture 6′ in the rotary member 3 so as to sit in the receptacle on the underside of the member 3, in engagement with annular surface 8 on the body member 1. The underside of the rotary member 3 has a hollowed out annular portion 3a of thickness corresponding to that of one coin. The coin C abuts a lug 3b that extends across the thickness of the receptacle onto the surface 8. This arrangement is described in more detail in our EP-A-0266021. As the motor 4 rotates the disc-like member 3 in the direction of arrow A, the coin C is swept towards the coin ejector device 11 as shown in FIG. 7B. In FIGS. 7A and 7B, the ejector device is in its coin engaging position corresponding to the arrangement of FIG. 5, in which the spring 15 biases the coin engaging members 11a, 11b to one end of the openings 12a, 12b. Thus, as shown in FIG. 7B, the coin C engages the first and second members 11a, 11b as the motor 4 rotates member 3 in the direction of arrow A.

Then, as shown in FIG. 7C, continued rotation of the member 3 causes the coin C to push back the member 11 against the bias of the spring 15, into the coin dispensing position so that, as shown in FIG. 7D, when the coin C becomes aligned with the coin outlet 10, the spring bias drives the coin engaging members 11a, 11b back towards the coin engaging position and “flicks” the coin C through the coin outlet. Then, as shown in FIG. 7E, the member 11 returns to the initial, coin engaging position and the coin C is paid out through the coin outlet 10.

Thus, the coin ejection process produces a back and forth rocking motion of the ejector member 11 which modulates the optical path 19 between the emitter and detector 17, 18 thereby producing a coin count signal each time the coin is ejected. Referring to FIG. 6, the coin count signals are counted by the controller 20 and compared with the payout instruction 21 so as to determine when a predetermined payout has been effected. The motor 4 is then de-energised in order to prevent overpayment.

An advantage of the described counting system is that the optical detectors are mounted entirely within the body member 1 making it difficult for a fraudster to tamper with them. In the event that the fraudster attempts to tamper with the ejector member 11, this also most certainly with produce a disabling effect on the entire coin dispensing apparatus thereby defeating the object of the fraudster.

In the event of a coin jam, the coin may continue to rotate past the coin ejecting member, driving it further along the openings 12a, 12b so that the coin engaging members rotate downwardly below the surface 8 and allow the coin to pass around in a complete rotation and thereby avoid jamming of the apparatus.

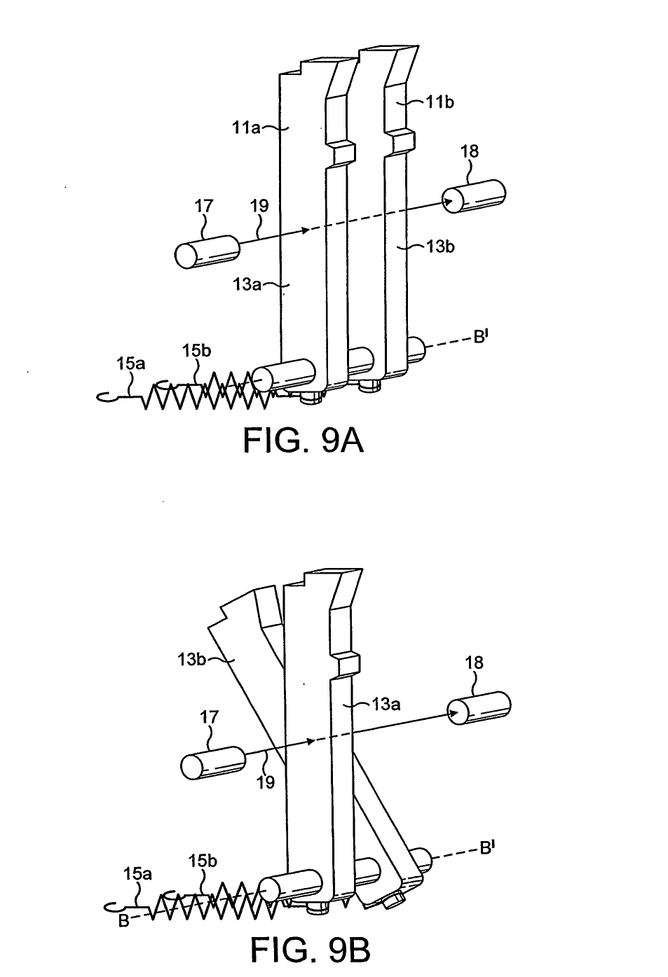

Referring now to FIGS. 8 and 9, an alternative ejector device for the dispensing apparatus is shown which is generally similar to the arrangement of FIG. 5 but in which the coin engaging members 11a, 11b are independently rotatable about the axis B-B′. Each coin engaging member 11a, 11b has a respective arm 13a, 13b biased by an individual spring 15a, 15b. As shown in FIG. 9B, movement of either of the arms 13a, 13b from the coin engaging position to the coin dispensing position will result in interruption of the optical path 19 between the optical emitter and detector 17, 18 thereby producing a count signal. This can also be seen from FIG. 8. The advantage of the independently movable members 11a, 11b is that a more even pressure is allied to the coin C during the ejection process since both of them can engage the perimeter of the coin and produce an individual flicking action to eject the coin through the outlet 10.

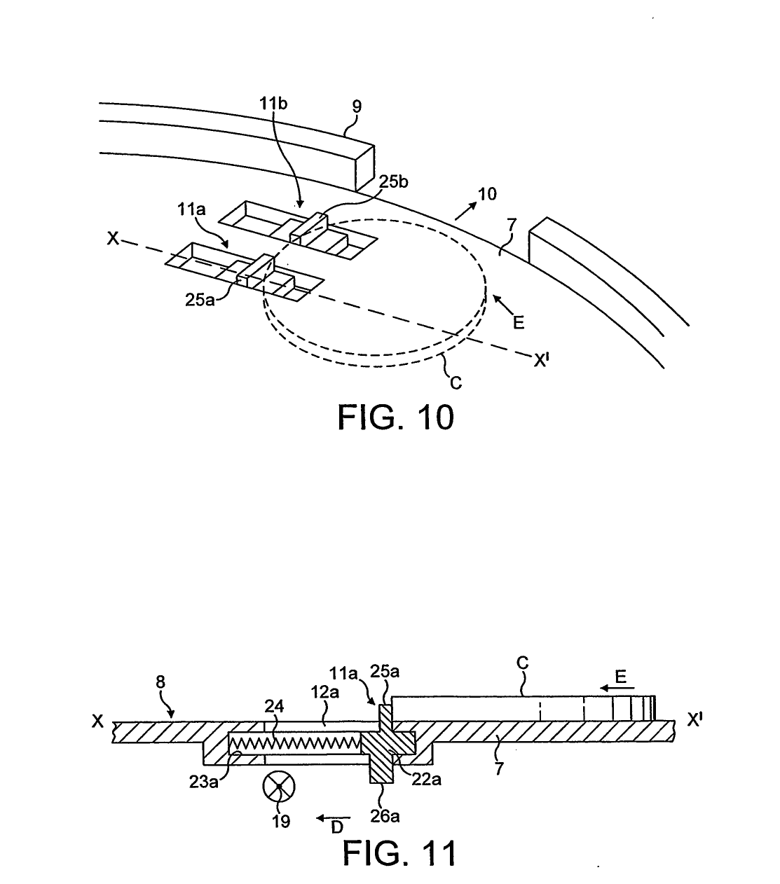

Another embodiment of ejector member is shown in FIGS. 10 and 11, in which the coin engaging members 11a, 11b are slidably mounted. The coin engaging member 11a is shown in sectional view in FIG. 11 and comprises a slider member 22a received in an integrally moulded slot 23a in the wall 7 that provides the annular surface 8 over which the coins C slide in use. The slider member 22a is biased by a compression spring 24a into the coin engaging position shown in FIG. 11. The slider member 22a can slide along the slot 23a in the direction of arrow D towards the coin dispensing position. The slider member 22a has an upstanding coin engaging part 25a which engages the edge of coin C when it is moved in the direction arrow E by the rotary member 3 (not shown in this Figure). The slider also includes a downwardly dependent arm 26a which interrupts the optical path 19 between the emitter and detector 17, 18 (not shown) to produce the coin counting signal each time. It will be understood that the second coin engaging member 11b has an identical construction to the arrangement of FIG. 11 so that when either of the members 25a, 25b move from the coin engaging position to the coin dispensing position, the optical beam 19 is interrupted and the coin counting signal is produced.

Many modifications and variations of the described example fall within the scope of the invention as claimed hereinafter.

As used herein, the term coin includes tokens and other coin-like items having an attributable monetary value.

1. Coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, and counting means responsive to movement of the ejector device to count coins ejected through the outlet

2. Apparatus according to claim 1 wherein the counting means comprises an optical emitter and detector, movement of the ejector device controlling passage of the radiation from the emitter to the detector in response to each coin ejected through the coin outlet whereby the detector provides a count signal corresponding to the ejected coins.

3. Apparatus according to claim 1 wherein the drive means comprises a spring urging the ejector device from the discharge position towards the coin engaging position.

4. Apparatus according to claim 1 including a body in which the motor and the ejector device are mounted, a flat surface on the body that receives coins from the source, the surface having an opening therein through which the ejector device protrudes to eject coins.

5. Apparatus according to claim 4 wherein the flat surface has an annular periphery bounded by a peripheral wall having the coin outlet therein.

6. Apparatus according to claim 4 wherein the coin source comprises a hopper mounted on the body.

7. Apparatus according to claim 1 wherein the ejector device comprises first and second coin engaging members movable between said coin engaging position and said discharge position.

8. Apparatus according to claim 7 wherein the coin engaging members are mounted for movement in unison.

9. Apparatus according to claim 7 wherein the coin engaging members are mounted for movement independently.

10. Apparatus according to claim 1 wherein the ejector device comprises at least one an arm configured to turn between said coin engaging position and said discharge position, and the counting means is operable to detect the turning of the arm in response to each coin ejected through the coin outlet.

11. Apparatus according to claim 1 wherein the ejector device comprises at least one slider member movable between the coin engaging position and the discharge position.

12. Coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, the ejector device comprising first and second coin engaging members movable independently between said coin engaging position and said discharge position.

13. Apparatus according to claim 12 wherein the first and second coin engaging members each comprise an arm configured to turn between said coin engaging position and said discharge position.

14. Apparatus according to claim 12 wherein the first and second coin engaging members each comprise a slider configured to slide between said coin engaging position and said discharge position.

15. Coin dispensing apparatus comprising a coin source, a rotary member with a plurality of coin receptacles to receive coins from the coin source, a motor to rotate the rotary member so as to move coins in the receptacles along an annular coin path, a coin outlet disposed to one side of the coin path, and a movable ejector device to eject coins from the receptacles through the coin outlet, the ejector device being positioned so that it is moved to from a coin engaging position to a discharge position by a coin as it moves along the annular path to be ejected through the coin outlet, drive means operable to drive the ejector device from the discharge position to eject the coin through the outlet and thence to the coin engaging position for a next approaching coin to be ejected, the ejector device comprising at least one slider member movable between the coin engaging position and the discharge position.
